(19) United States
(12) Patent Application Publication
(10) Pub. No.: US 2025/0366471 A1
(43) Pub. Date: Dec. 4, 2025

(54) WETTABLE POWDER AND WATER DISPERSIBLE GRANULE

(71) Applicant: CRODA INTERNATIONAL PLC, Goole, East Yorkshire (GB)

(72) Inventors: Carlos Eduardo Oliveira DA SILVA, Campinas (BR); Raquel Cristina Bacochina TOMBOLY, Campinas (BR); Marcia Fernanda Hergert Pereira WERNER, Campinas (BR); Gabriel Lavansdoski ONAGA, Campinas (BR)

(73) Assignee: CRODA INTERNATIONAL PLC, Goole, East Yorkshire (GB)

(21) Appl. No.: 18/869,191

(22) PCT Filed: May 26, 2023
(86) PCT No.: PCT/EP2023/064204

§ 371 Date: Nov. 25, 2024

(30) Foreign Application Priority Data
May 27, 2022 (GB) 2207867.9

(51) Int. Cl. A01N 25/14; A01N 63/30; A01P 15/00

(52) U.S. Cl. CPC A01N 25/14; A01N 63/30; A01P 15/00

(57) ABSTRACT

A novel wettable power or water dispersible granule for agrochemical formulations. Said wettable power or water dispersible granule comprising dispersants, mineral based fillers, and microorganism or microbes. Where the dispersants in particular are selected from acrylic copolymers and copolymer of acrylic acid with hydrophobic monomers and alkylacrylate of a monoalkyl polyethylene glycol. The fillers are in particular mica particles coated with metal oxide, kaolin, silica, or calcium carbonate. A pre-blend is also provided for forming the formulation. There is also provided the use of said wettable power or water dispersible granule for treating vegetation to control pests by applying the formulation, or use for seed coatings.

The present invention relates to microorganism formula table wettable powders and water dispersible granules for use in agrochemical and agronomic active formulations. The present invention also includes methods of treating crops with such formulations.

The use of biological control agents is a growing segment in agribusiness due to their effectiveness in crop protection and crop enhancement, and due to providing a sustainable alternative to conventional methods. Recently there has been a significant increase in the number of companies interested in the development and production of biopesticides and biofertilisers formulations based on microorganisms such as fungi and bacteria.

When formulating microorganisms, it is usual to select the best species, strains and structures to provide the best performance (agronomic efficacy) and stability (shelf-life). Fungi are usually formulated using conidia form (spores) due to its best survival within time but it is necessary to formulated those in oil or solids as water content above certain level may contribute to unwanted germination of the spores during storage and reducing shelf life of the formulation in the package.

However, these kinds of solid based formulation present several technical problems which make expansion of the market for them difficult. These technical problems include maintaining formulation quality, poor water dispersibility, low wettability capacity (e.g. due to the hydrophobic nature of spores), problems during the application such as nozzles clogging, low opening speed in water, bad dispersibility in tank mixing, heterogeneity in field application and stability of microorganism in the formulation for the medium/long term. All these problems can affect drastically the final quality of biopesticides and/or biofertilisers, affecting the quality of application of such products in the field and the performance of the biopesticide or biofertilisers when in contact with the target pest/disease.

The present invention therefore, seeks to provide wettable powder (WP) and water-dispersible granules (WDG), compounds for forming thereof, suitable for use with biological pesticides or biological fertilizers, where said WP and WDGs are able to overcome the above described problems. Additionally, the present invention seeks to provide WP and WDGs which have improved wettability and opening speed without significantly affecting the survivability of microorganism biopesticide or biofertilizers and its performance in the field. The present invention provides for the use of the WP/WDGs for dilution for use on field sprays, or as seed treatments.

According to a first aspect of the present invention there, is provided a wettable power or water dispersible granule comprising:
(i) dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates;
(ii) mineral based filler selected from:
   mica particles coated with metal oxide; or
   kaolin, silica, or calcium carbonate;
   having particle size 1 μm to 100 μm and bulk density 0.2 g/mL to 0.6 g/mL;
   and
(iii) at least one microorganism selected from fungal spores, or microbes with biopesticide or biofertiliser effects.

According to a second aspect of the present invention there, is provided a wettable power or water dispersible granule comprising:
(i) dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates;
(ii) mineral based filler selected from particles with particle size 1-60 μm, bulk density 0.2-0.6 g/ml, and optionally water absorption capability greater than 50%; and
(iii) at least one microorganism selected from fungal spores, or microbes with biopesticide or biofertiliser effects.

According to a third aspect of the present invention there is provided a pre-blend suitable for forming a wettable power or water dispersible granule of the first aspect, the preblend comprising
dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates,
and mineral based filler selected from:
   mica particles coated with metal oxide; or
   kaolin, silica, or calcium carbonate;
      having particle size 1 μm to 100 μm and bulk density 0.2 g/mL to 0.6 g/mL.

According to a fourth aspect of the present invention there is provided a method of making a wettable powder or water dispersible granule of the first aspect, said method comprising mixing a pre-blend in accordance with the second aspect with at least one microorganism selected from fungal spores or microbes with biopesticide or biofertiliser effects.

According to a fifth aspect of the present invention there is provided a formulation suitable for application to vegetation, said formulation comprising a diluted suspension of the wettable powder or water dispersible granule of the first aspect.

According to a sixth aspect of the present invention there is provided a seed treatment formulation, said formulation comprising the wettable powder or water dispersible granule of the first aspect.

According to a seventh aspect of the present invention there is provided a method of treating seeds to control pests, the method comprising applying a formulation of the fifth aspect to said seeds.

According to an eighth aspect of the present invention there is provided a method of treating vegetation to control pests, the method comprising applying a diluted formulation of the first aspect, either to said vegetation or to the immediate environment of said vegetation.

According to a ninth aspect of the present invention there is provided a method for improving viability of at least one beneficial microorganism on an agricultural target comprising the step of combining said beneficial microorganism, selected from fungal spores or microbes with biopesticide or biofertiliser effects, with at least one dispersant and mineral based filler as defined in the first aspect on said agricultural target.

It has been found that use of dispersant with filler and with a biopesticide provides for a better wettability capacity for fungi spores formulated as wettable powder or water dispersible granules allowing a better homogenisation in tank mixture and reducing issues in application. There is also potential use of this formulation on final stage of seed treatment along with or in replacement of drying powders (depending on dosage required of spores). It was observed that the use of dispersants and fillers as noted in this application can improve the survival of the biopesticide or biofertiliser in WP and WDGs.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure and are not meant to be limiting in any fashion.

It will be understood that, when describing the number of carbon atoms in a substituent group (e.g. ‘C₁ to C₆ alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

When referring to microorganisms, in this application it includes specifically fungi and bacteria which are presented in solid form and are have relevant use in the agriculture as biological control agents, biopesticide, or biological fertilisers.

The dispersing agent is preferably selected from any suitable dispersant including dispersants such as sulphonated naphthalene formaldehyde condensates; acrylic copolymers such as the comb copolymer having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates.

The dispersing agent may preferably be selected from a water dispersible styrene (meth)acrylic copolymer. The water dispersible styrene (meth)acrylic copolymer used in this invention is for convenience sometimes referred to below as a polymeric dispersant. The polymeric dispersant is a styrene (meth)acrylic acid copolymer. The repeating units in the copolymer are conveniently considered as residues of monomer components.

The (meth)acrylic acid monomer(s) can be acrylic acid, methacrylic acid, crotonic acid or a mixture of two or more of these. The (meth)acrylic acid monomer(s) can be or include (meth)acrylic monomers which are derivatives of (meth)acrylic acid which include strong acid, especially sulphate acid or sulphonic acid groups (or their salts). Examples of such monomers include acrylamido methyl propyl sulphonate (AMPS) and (meth)acrylic acid isethionate. When present such strong acid modified monomers usually form from 1 to 30 mole %, more usually 2 to 20 mole %, and desirably from 5 to 15 mole %, of the acrylic acid monomers in the copolymer.

The styrene monomer(s) can be, and desirably is, styrene as such or a substituted styrene particularly a hydrocarbyl, desirably alkyl, substituted styrene, in which the substituent(s) are on the vinyl group or on the aromatic ring of the styrene e.g. α-methyl styrene and vinyl toluene. As with the (meth)acrylic acid monomer, the styrene monomer can be or include styrene monomers including strongly acid, particularly sulphonic acid substituents. When present such strong acid modified monomers usually form from 1 to 30 mole %, more usually 2 to 20 mole %, and desirably from 5 to 15 mole %, of the styrene monomers in the copolymer.

In the water dispersible styrene (meth)acrylic copolymer used in the invention, the molar ratio of residues of the (meth)acrylic acid monomer(s) to those of the styrene monomer(s) is generally from 20:1 to 1:5, more usually 10:1 to 1:2 and particularly from 3:1 to 1:1. Generally correspondingly, the proportions of residues of the monomers by weight are typically from 93 to 10%, more usually 87 to 25%, particularly 67 to 40%, of the (meth)acrylic acid monomer(s) and from 7 to 90%, more usually 13 to 75%, particularly 33 to 60%, of the styrene monomer(s).

Other monomers, such as acidic monomers e.g. itaconic acid or maleic acid or anhydride; strongly acidic monomers such as methallyl sulphonic acid (or a salt); or non-acidic acrylic monomers e.g. acrylic esters which may be alkyl esters particularly C₁ to C₆ alkyl esters such as methyl methacrylate, butyl methacrylate or butyl acrylate or hydroxy alkyl esters particularly C₁ to C₆ hydroxyalkyl esters such as hydroxy ethyl methacrylate, or hydroxy propyl methacrylate; or vinyl monomers such as vinyl acetate, can be included. Typically, the proportion of such other monomer(s) will be not more than about 25 mole %, usually not more than about 15 mole %, more usually not more than about 5 mole %, of the total monomers used. The proportion by weight of other monomers will typically be not more than about 30%, usually not more than about 20%, more usually not more than about 10%.

The polymeric dispersant can be a single styrene acrylic acid copolymer or a blend including two or more such copolymers. In particular, when strong acid residues are included in the polymeric dispersant, the dispersant can be a blend of copolymer including strong acid residues and copolymer not including such residues. In such blends, it is generally desirable that the ratio of such copolymers is from 1:10 to 10:1, more usually 5:1 to 1:5, by weight. In particular, the proportion of copolymer including strong acid residues is desirably at least 25%, more usually at least 40%, by weight of the polymeric dispersant.

When strong acid residues are included in the polymeric dispersant, the overall proportion of monomer residues including strong acid groups is desirably from 0.25 to 25 mole %, more usually from 0.5 to 20 mole % and desirably from 1 to 10 mole %.

The inclusion of monomers having strongly acidic substituent groups in the polymeric dispersant can provide improved dispersion of the solid granular form of the agrochemical formulations when dispersed in hard water, particularly water having a hardness above 500 ppm e.g. up to 1,000 ppm, up to 2,000 ppm or even up to 5,000 ppm.

The polymeric dispersant desirably has a molecular weight of from 750 to 20,000, more desirably from 1,000 to 10,000 and particularly from 1,500 to 5,000. The polymeric dispersant can be used as the free acid or as a salt. In practice, the form present in a formulation will be determined by the acidity of the formulation. Desirably, the formulation will be near neutral and so most of the acid groups will be present as salts. The cations in any such salt can be alkali metal, particularly sodium and/or potassium, ammonium, or amine, including alkanolamine such as ethanolamine, particularly tri-ethanolamine. Polymeric dispersants used in this invention are desirably free from solvent which might interfere with the active ingredient or cause the granules to stick together. Also it is useful if the polymeric dispersant can be used satisfactorily in a variety of different granulation processes. Further desirably the polymeric dispersant is heat stable, readily soluble in cold water from the solid dispersible granule (satisfactory polymeric dispersants need not be readily cold water soluble from the bulk solid form) and non-gelling.

The polymeric dispersants can be made by free radical initiated polymerisation, e.g. using a peroxide or a redox initiator, particularly by solution polymerisation, of the constituent monomers, optionally also with a chain transfer agent such as an alkyl mercaptan which acts to control the molecular weight of the polymer. Suitable methods are described for example in EP 0697422 A.

The dispersant may be selected from a copolymer dispersant comprising a copolymer of acrylic acid, hydrophobic monomer, alkylacrylate of a monoalkyl polyethylene glycol, and optionally strong acid derivatives of (meth)acrylic acid.

The acrylic acid monomer used to form the copolymer may be selected from (meth)acrylic acid or salts thereof, (meth)acrylamide, (meth)acrylonitrile, C₁₋₆-alkyl (meth)acrylates such as ethyl (meth)acrylate, butyl (meth)acrylate or hexyl (meth)acrylate, 2-ethylhexyl (meth)acrylate, substituted C₁₋₆-alkyl (meth)acrylates such as glycidyl methacrylate and acetoacetoxyethyl methacrylate, di(C₁₋₄-alkylamino) C₁₋₆-alkyl (meth)acrylates such as dimethylaminoethyl acrylate or diethylaminoethyl acrylate, amides formed from C₁₋₆-alkylamines, substituted C₁₋₆-alkyl-amines such as 2-amino-2-methyl-1-propane sulphonic acid, ammonium salt, or di(C₁₋₄-alkyl-amino) C₁₋₆-alkylamines and (meth)acrylic acid and C₁₋₄-alkyl halide adducts thereof.

Preferably the acrylic acid monomer may be acrylic acid, methacrylic acid, crotonic acid, or a mixture thereof. More preferably, the monomer is acrylic acid.

The hydrophobic monomer may be selected from any monomer which is water insoluble. In particular, the hydrophobic monomer may be selected from hydrophobic alkyl (meth)acrylates, styrenes, and vinyl compounds, and vinyl aromatic monomers.

In particular vinyl aromatic monomers may be preferred.

The vinyl aromatic monomer(s) can be, and desirably is, styrene as such or a substituted styrene particularly a hydrocarbyl, desirably alkyl, substituted styrene, in which the substituent(s) are on the vinyl group or on the aromatic ring of the styrene e.g. α-methyl styrene and vinyl toluene.

Suitable vinyl aromatic monomers may preferably comprise from 8 to 20 carbon atoms, most preferably from 8 to 14 carbon atoms. Styrenes and substituted styrenes are preferred where the substituent group, if present, is a C₁-C₆ alkyl groups.

Examples of vinyl aromatic monomers are styrene including substituted styrene, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, alpha-methylstyrene, and halogenated styrenes.

Preferably the hydrophobic monomer may be styrene, α-methyl styrene, p-methyl styrene, t-butyl styrene, or a combination thereof. More preferably, the hydrophobic monomer may be styrene.

The alkylacrylate of a monoalkyl polyethylene glycol may preferably be a non-ionic hydrophilic monomer.

The alkyl group either as part of the alkylacrylate or monoalkyl groups, may independently be selected from a C₁-C₆ alkyl, and in particular a C₁-C₃ alkyl. The alkyl group may preferably be selected from methyl, ethyl, n-butyl, or t-butyl. Preferably the alkyl group is methyl.

The number-average molecular mass of the monoalkyl polyethylene glycol (i.e. the PEG chain only and not the whole alkylacrylate of a monoalkyl polyethylene glycol) may be at least 300 daltons, preferably ranging from 350 to 900 daltons, more preferably in the range from 400 to 600 daltons.

Some of the monoalkyl polyethylene glycols employed as initial materials in this invention occur in commerce. Thus methyl ethers of total molecular weights of 500 and 550, and designated, respectively, in commerce as methoxy polyethylene glycol 550 and methoxy polyethylene glycol 750, are available on the market.

Preferably, the alkylacrylate of a monoalkyl polyethylene glycol is a methoxy polyethylene glycol methacrylate (MPEGMA), and more particularly a methoxy polyethylene glycol 500 methacrylate.

Strong acid derivatives of (meth)acrylic acid, may include strong acids comprising sulphate acid or sulphonic acid groups (or their salts). Examples of such monomers include acrylamido methyl propyl sulphonate (AMPS) and (meth)acrylic acid isethionate.

When present such strong acid modified monomers usually form from 1 to 30 mol. %, more usually 2 to 20 mol. %, and desirably from 5 to 15 mol. %, of the acrylic acid monomers in the copolymer.

The polymer may be formed from hydrophobic monomers and may be a water soluble polymer, said solubility arising as a result of neutralisation of the polymer.

It will be understood that the terms “copolymer” as used herein includes polymers with two components as well as ter-polymers and terta polymers, and generally any polymer with two or more components. The copolymer may preferably be a random ter-polymer or tetra polymer, optionally with a strong acid derivatives of (meth)acrylic acid monomer.

The copolymer may be formed by any suitable method, and this may include free radical solution polymerisation or controlled living polymerisation. The monomers may be added concurrently in a controlled manor over a period of time with suitable initiator.

The amount of acrylic acid monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40 wt. %.

The amount of vinyl aromatic monomer present in the polymer may be in the range from 10 wt. % to 90 wt. %. Preferably, 15 wt. % to 60 wt. %. More preferably from, 15 wt. % to 40 wt. %. Most preferably, from 20 wt. % to 30 wt. %.

The amount of alkylacrylate of a polyethylene glycol monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40 wt. %.

When present such strong acid modified monomers usually form from 1 to 30 wt. %, more usually 2 to 20 wt. %, desirably from 5 to 15 wt, and most preferably from 8 to 12 wt. %, of the acrylic acid monomers in the copolymer

Other monomers, such as acidic monomers e.g. itaconic acid or maleic acid or anhydride; strongly acidic monomers such as methallyl sulphonic acid (or a salt); or non-acidic acrylic monomers e.g. acrylic esters which may be alkyl esters particularly C₁ to C₆ alkyl esters such as methyl methacrylate, butyl methacrylate or butyl acrylate or hydroxy alkyl esters particularly C₁ to C₆ hydroxyalkyl esters such as hydroxy ethyl methacrylate, or hydroxy propyl methacrylate; or vinyl monomers such as vinyl acetate, can be included. Typically, the proportion of such other monomer(s) will be not more than about 10 mol. %, usually not more than about 7 mol. %, more usually not more than about 5 mol. %, of the total monomers used.

The polymer may have a molecular weight less than 500,000 Daltons. Preferably, less than 100,000 Daltons. More preferably, less than 75,000 Daltons. The molecular weight may be in the range from 5,000 to 75,000 Daltons. More preferably, in the range from 10,000 to 60,000 Daltons. Further preferably, in the range from 15,000 to 50,000 Daltons. Most preferably, in the range from 20,000 to 40,000 Daltons.

The polymer can be used as the free acid or as a salt. In practice, the form present in a formulation will be determined by the acidity of the formulation. Desirably, the formulation will be near neutral and so most of the acid groups will be present as salts. The cations in any such salt can be alkali metal, particularly sodium and/or potassium, ammonium, or amine, including alkanolamine such as ethanolamine, particularly tri-ethanolamine. In particular, sodium or potassium salts forms of the stabilising polymer are preferred.

The polymer or monomers comprised therein may be neutralised with at least 50% neutralising agent. Preferably, may be neutralised with at least 70%, and preferably 75%-85% neutralising agent. Neutralisation with sodium is preferred.

The pH of the polymer may be in the range from 4.0 to 11.0. More preferably, in the range from 5.0 to 10.0. Further preferably, in the range from 5.5 to 9.0. Most preferably, in the range from 6.0 to 8.0.

The dispersant may be selected from a non-ionic graft copolymer of acrylic ester and oxyalkylene.

The acrylic ester may be a non-acidic acrylic monomers, for example acrylic esters which may be selected from alkyl esters, particularly C₁ to C₆ alkyl esters. Preferably, said alkyl esters may be selected from methyl methacrylate, butyl methacrylate or butyl acrylate. Most preferably, methyl methacrylate.

The number of acrylic ester monomer residues in the (poly) acrylic ester chains, will preferably be in the range from 2 to 50, more preferably 5 to 40, and particularly 10 to 30.

The oxyalkylene groups may be selected from groups of the formula —(C_{y}H_{2y}O)— where y is an integer selected from 2, 3, or 4. Preferably, y is 2 or 3. The oxyalkylene group may be selected from oxyethylene, oxypropylene, oxybutylene, or oxytetramethylene. Preferably, the oxyalkylene group is selected from oxyethylene (EO) and/or oxypropylene (PO).

Where the oxyalkylene chain is homopolymeric, homopolymers of ethylene oxide or propylene oxide are preferred. More preferably, homopolymers of ethylene oxide are particularly preferred.

Where there is more than one oxyalkylene group present (i.e. where n is 2 or more) and at least two are part of the same oxyalkylene chain, the oxyalkylene groups may be the same or may be different along said oxyalkylene chain. In this embodiment, the oxyalkylene chain may be a block or random copolymer 5 of differing oxyalkylene groups.

Usually, where co-polymeric chains of oxyethylene and oxypropylene units are used the molar proportion of oxyethylene units used will be at least 50% and more usually 10 at least 70%.

The total number of alkylene oxide residues in the (poly)alkylene oxide chains, will preferably be in the range from 2 to 50, more preferably 5 to 40, and particularly 10 to 25.

The molecular weight of the non-ionic graft copolymer of acrylic ester and oxyalkylene is typically from 5,000 to 40,000, particularly from 7,000 to 30,000, more particularly from 8,000 to 25,000 and especially about 9,000 to 18,000.

Any non-ionic graft copolymer of acrylic ester and oxyalkylene may be used. Preferably, the copolymer may be non-ionic polymethyl methacrylate-polyethylene oxide graft copolymer.

Other suitable dispersants may include napthalene sulphonate blends, sodium N-methyl oleoyl taurate, or sodium dioctyl sulfosuccinate, or sodium lignosulfonates.

The filler may be selected from mica particles coated with metal oxide, kaolin, calcium carbonate, or silica. Said particles having particle size 1 μm to 100 μm and bulk density 0.2 g/mL to 0.6 g/mL

In some instances, the substrate material comprises mica coated with a layer of a metal oxide, including but not limited to titanium dioxide, iron oxide, chromium oxide, or zirconium oxide.

In particular, preferred fillers include silica, or titanium coated mica. Particularly preferably fillers may be selected from mica particles coated with layer of titanium dioxide in anatase or rutile form, or iron oxide.

The bulk density of the filler may preferably be in the range 0.20 to 0.60 mg/L, more preferably in the range 0.25 to 0.55 mg/L, more preferably in the range 0.30 to 0.53 mg/L.

It will be understood that, unless stated otherwise, bulk density values described herein refer to tapped bulk density, where the tapped density refers to the bulk density of the powder after a specified compaction process, usually involving vibration of the container. Bulk density in relation to the present invention is determined pursuant to CIPAC MT033 Content Handbook F “Tap Density”.

The filler, suitably has a median particle size in the range from 0.1 to 50 μm, preferably 0.5 to 30 μm, more preferably 0.8 to 25 μm. Most preferably, 1 to 20 μm.

The particle size values, used to determine mean particle size values, are measured by techniques based on laser diffraction. The filler sample is dispersed in water media and homogenized, this dispersion is analyzed by an equipment that generates information of the particle size distribution by laser diffraction (for example Malvern Masterziser). The result is presented as a curve of the distribution of sizes calculated by the software and also data of the percentile values D10, D50 and D90 that are statistical parameters of the cumulative particle size distribution, they indicate the size below which 10%, 50% or 90% of all particles are found.

The weight average molecular weight of the filler particles starting material may be in the range from 1,000 to 5,000,000. Preferably, in the range from 50,000 to 2,000,000. More preferably, in the range from 100,000 to 1,000,000, and most preferably 150,000 to 300,000.

The filler particles may be homogeneous in that it is comprised of only one specific type of filler, for example all of the same composition and/or having identical molecular weights. In an alternative embodiment, the filler particles may be heterogeneous in that they comprise a mixture, such as a mixture having different molecular weights.

The mineral based filler may preferably have a water absorption capability greater than 50%, preferably greater than 60%. Water absorption refers to the ability of material to absorb water when immersed in it and is represented with water absorbing capacity, this being the ratio of the weight of water absorbed by a material in saturated state over the weight of the dry material.

The dispersant and filler are combined to provide a preblend formulation which is suitable for forming in to a WP or WDG. The preblend comprises, may consist essentially of, or may consist of, the dispersant and filler.

The amount of dispersant comprised in the preblend may be in the range of between 2 wt. % and 20 wt. %. More preferably, in the range of between 4% and 15%. Further preferably, in the range of between 5% and 12%. Most preferably, in the range of between 6% and 10%, as a percentage of the total preblend.

The amount of filler comprised in the preblend may be in the range of between 98 wt. % and 80 wt. %. More preferably, in the range of between 96% and 85%. Further preferably, in the range of between 95% and 88%. Most preferably, in the range of between 94% and 90%, as a percentage of the total preblend.

The weight ratio of dispersant to filler in the preblend is preferably from about 0.05:1 to about 0.2:1. More preferably, from about 0.08:1 to about 0.12:1. This ratio range will generally be maintained for the preblend, the WP/WDG, and the diluted WP/WDG used in a spray formulation.

The microorganisms, in this application, relates to fungi and bacteria which are presented in solid form and are have relevant use in the agriculture as, biological control, bio-control agents, biopesticides and/or biological fertilisers or biofertilisers.

Biopesticides by nature attack other microorganisms and/or macroorganisms through several mechanisms and hence have been considered for many years as a means of combatting pests, particularly those found in agriculture and the like. For example, bacteria which are thus toxic to insects have been long known and commercial insecticides based on such bacteria have been now available for a number of years.

Another important example, it is use of fungi and/or bacteria those produces some secondary metabolic components (e.g. antibiotics, fungicides, bactericides, enzymes) to control the plant diseases and/or insects pest.

Biological pesticides have the clear and substantial advantage of being selective or highly specific to particular targets and in general they are environmentally safe. Hence, they have been of increasing interest and attraction in recent years.

The biopesticide active may preferably be any microbiological organisms customary for plant, seed or soil treatment. Biopesticides refer to biological actives which, in the context of the present invention, are plant protection agents, more particular microorganisms capable of killing and/or able to control, through different mechanisms, different forms of malefic organisms to agriculture crops (such as pest and/or plant diseases).

The biopesticide may include biological fungicides, herbicides, insecticides, algicides, moluscicides, miticides, and rodenticides.

The biopesticides may in particular be selected from microbes as spores and/or another structure of fungi, bacteria, yeast and/or actinomycetes, but not limited.

A biofertiliser is characterised as substance which contains living microorganisms which, when applied to seeds, plant surfaces, or soil, can colonise the rhizosphere or the interior of the crop plants and promotes growth by increasing the supply or availability of primary nutrients to the host plant. Biofertilisers are able to provide nutrients to plants through the natural processes, such as of nitrogen fixation, solubilising phosphorus and/or stimulating plant growth through the synthesis of growth-promoting substances (such as precursors of auxins, gibberellins, ethylene). The use of biofertilisers can be expected to reduce the use of synthetic fertilisers and pesticides during the crop season.

The biofertilisers may in particular be selected from microbes as spores and/or another structure of fungi, bacteria and/or yeast.

The preferred biofertilising bacterial strains may be selected from the genera Rhizobium, Sinorhizobium, Mesorhizobium, Bradyrhizobium, Azorhizobium, and Allorhizobium.

The preblend would be combine with microorganisms spores and/or another microbial structure to form a WP or WDG.

The amount of dispersant comprised in the WP/WDG may be in the range of between 1 wt. % and 20 wt. %. More preferably, in the range of between 2% and 15%. Further preferably, in the range of between 3% and 10%. Most preferably, in the range of between 4% and 7%, as a percentage of the total WP/WDG.

The amount of filler comprised in the WP/WDG may be in the range of between 98 wt. % and 40 wt. %. More preferably, in the range of between 92% and 50%. Further preferably, in the range of between 90% and 60%. Most preferably, in the range of between 87% and 62%, as a percentage of the total WP/WDG.

The amount of biopesticide or biofertiliser comprised in the WP/WDG may be in the range of between 40 wt. % and 5 wt. %. More preferably, in the range of between 35% and 7%. Further preferably, in the range of between 32% and 8%, as a percentage of the total WP/WDG.

Both wettable powder (WP) and water-dispersible granule (WDG) are found to be particularly effective forms of formulations for inclusion of high amounts of biopesticide or biofertilisers spores and/or other microbial structures.

Wettable powder will be understood to be a system of spores and/or other microbial structures of biopesticide or biofertiliser, surfactant/dispersant, and filler that forms a suspension with water. The WP may comprise wetting agent to facilitate the suspension of particles in water. WP may be used for spray formulations and/or seed coating formulations.

Water-dispersible granules will be understood to be granular sized particle formulation of wettable powders to be applied after disintegration and dispersion in water. WDGs typically composed of a mixture of active, wetting agent, dispersant, and filler/diluent/disintegrant formulated as a powder and processed in to granules. WDGs may particularly be suitable for use in spray formulations.

Spores/microbes or other structures comprising formulation is put in a spray tank to spray on to a field or applied to seeds.

The WP and WDGs are designed to be diluted with water (or a water-based liquid) to form the corresponding end-use agronomic and agrochemical formulations, typically spray formulations.

Regarding the agronomic efficacy, active compounds require a formulation which allows the active compounds to be taken up by the plant/the target organisms. When concentrates (solid or liquid) are used as the source of active agrochemical and/or adjuvant, the concentrates will typically be diluted to form end-use formulations, typically spray formulations.

The dilution may be with water at from 1 to 10,000, particularly 10 to 1,000, times the total weight of the concentrate to form the spray formulation.

Said WP/WDGs may be diluted for use resulting in a dilute composition resulting in a agrochemical active concentration of about 0.5 wt. % to about 5 wt. %. In said dilute composition (for example, a spray formulation, where a spray application rate may be from 10 to 500 1.ha⁻¹) the biological active concentration may be in the range from about 0.001 wt. % to about 2 wt. % of the total formulation as sprayed

Spray formulations are aqueous agronomic formulations including all the components which it is desired to apply to the plants or their environment. Spray formulations can be made up by simple dilution of the WP/WDGs containing desired components (other than water), or a combination of diluting WP/WDGs and adding further individual components or mixtures of components. Typically such end use mixing is carried out in the tank from which the formulation is sprayed, or alternatively in a holding tank for filling the spray tank. Such mixing and mixtures are typically termed tank mixing and tank mixtures.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

The agrochemical formulation may include solvents (other than water) such as monopropylene glycol, oils which can be vegetable or mineral oils such as spray oils. Such solvents may be included as a solvent for the surfactant adjuvant, and/or as a humectant, e.g. especially propylene glycol. When used such solvents will typically be included in an amount of from 5 wt. % to 500 wt. %, desirably 10 wt. % to 100 wt. %, by weight of the surfactant adjuvant. Such combinations can also include salts such as ammonium chloride and/or sodium benzoate, and/or urea especially as gel inhibition aids

The diluted WP/WDG tank mix may be sprayed on soil or used as a foliar spray.

The described WP/WDG formulations may also be applicable for use in seed treatments and seed coatings, for example in water film coating for seeds, such as film coating, encrustment, or pelleting.

The WP/WDG formulations may be applied to seeds when diluted in water prior application in liquid form. Alternatively, they may be applied as part of a drying powder during seed treatment process.

The WP/WDG formulation described here, may be applied during the film coating process, encrustment process, or pelleting process.

In particular, the present invention may find preferred use when treating seeds selected from corn, soybean, forages, and lettuce.

The preblend, WP/WDG, seed coating formulation, or diluted WP/WDG may also include other components as desired. These other components may be selected from those including:
binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The preblend, WP/WDG, seed coating formulation, or diluted WP/WDG may also include agrochemical actives or nutrients as desired.

The agrochemical active may preferably be a solid phase agrochemical active. Solid agrochemical active compounds are to be understood in the present invention as meaning all substances customary for plant or seed treatment, whose melting point is above 20° C. (at standard pressure). Solid agrochemical actives will also include insoluble active ingredients, i.e. active ingredients whose solubility in water is such that a significant solid content exists in the concentrate after addition.

Agrochemical actives refer to biocides which, in the context of the present invention, are plant protection agents, more particular chemical substances capable of killing and/or control different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides, and rodenticides; and
antimicrobials, including germicides, antibiotics, antibacterials, antivirals, antifungals, antiprotozoals, and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest or plant disease. A pesticide may be a chemical substance or biological agent (such as a virus, fungi or bacteria) used against pests including insects, plant pathogens, weeds, mollusks, birds, mammals, fish, nematodes (roundworms), and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when sprayed on its surface. A systemic fungicide has to be absorbed by the plant before the fungus dies.

Examples for suitable fungicides, according to the present invention, encompass the following species: (3-ethoxypropyl)mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, DONATODINE, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

An herbicide is a pesticide used to kill unwanted plants. Selective herbicides kill specific targets while leaving the desired crop relatively unharmed. Some of these acts by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Suitable herbicides may be selected from the group comprising: aryloxycarboxylic acid e.g. MCPA, aryloxyphenoxypropionates e.g. clodinafop, cyclohexanedione oximes e.g. sethoxydim, dinitroanilines e.g. trifluralin, diphenyl ethers e.g. oxyfluorfen, hydroxybenzonitriles e.g. bromoxynil, sulphonylureas e.g. nicosulphuron, triazolopyrimidines e.g. penoxsulam, triketiones e.g. mesotriones, or ureas e.g. diuron.

Particularly preferred herbicides may be selected from 2,4-dichlorophenoxyacetic acid (2,4-D), atrazine, dicamba as benzoic acid, glyphosate, imazapic as imidazolinone, metolachlor as chloroacetamide, picloram, clopyralid, and triclopyr as pyridinecarboxylic acids or synthetic auxins.

An insecticide is a pesticide used against insects in all developmental forms and includes ovicides and larvicides used against the eggs and larvae of insects. Insecticides are used in agriculture, medicine, industry and the household.

Suitable insecticides may include those selected from:
Chlorinated insecticides such as, for example, Camphechlor, DDT, Hexachlorocyclohexane, gamma-Hexachlorocyclohexane, Methoxychlor, Pentachlorophenol, TDE, Aldrin, Chlordane, Chlordecone, Dieldrin, Endosulphan, Endrin, Heptachlor, Mirex, and mixtures thereof;
Organophosphorous compounds such as, for example, Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulphoton, Ethoprop, Fenamiphos, Fenitrothion, Fenthion, Fosthiazate, Malathion, Methamidophos, Methidathion, Methyl-parathion, Mevinphos, Naled, Omethoate, Oxydemeton-methyl, Parathion, Phorate, Phosalone, Phosmet, Phostebupirim, Pirimiphos-methyl, Profenofos, Terbufos, Tetrachlorvinphos, Tribufos, Trichlorfon, and mixtures thereof;
Carbamates such as, for example, Aldicarb, Carbofuran, Carbaryl, Methomyl, 2-(1-Methylpropyl)phenyl methylcarbamate, and mixtures thereof;
Pyrethroids such as, for example, Allethrin, Bifenthrin, Deltamethrin, Permethrin, Resmethrin, Sumithrin, Tetramethrin, Tralomethrin, Transfluthrin, and mixtures thereof;
Plant toxin derived compounds such as, for example, Derris (rotenone), Pyrethrum, Neem (Azadirachtin), Nicotine, Caffeine, and mixtures thereof;
Neonicotinoids, such as imidacloprid;
Abamectins, e.g. emamactin;
Oxadiazines, such as indoxacarb;
Anthranilic diamides such as rynaxypyr.

Rodenticides are a category of pest control chemicals intended to kill rodents. Suitable rodenticides may include anticoagulants, metal phosphides, phosphides, and calciferols (vitamins D), and derivatives thereof.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs and snails. These substances include metaldehyde, methiocarb and aluminium sulphate. A nematicide is a type of chemical pesticide used to kill parasitic nematodes (a phylum of worm).

In the following examples, antimicrobials suitable for agrochemical compositions according to the present invention are given.

Bactericidal disinfectants may include those selected from active chlorines, active oxygen, iodine, concentrated alcohols, phenolic substances, cationic surfactants, strong oxidisers, heavy metals and their salts, and concentrated strong acids and alkalis between pH of from 1 to 13. Suitable antiseptics (i.e., germicide agents that can be used on human or animal body, skin, mucoses, wounds and the like) may include diluted chlorine preparations, iodine preparations, peroxides, alcohols with or without antiseptic additives, weak organic acids, phenolic compounds, and cation-active compounds.

Particular preference is given to active compounds from the classes of the azole fungicides (azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidol, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforin, triticonazole, uniconazole, voriconazole, viniconazole), strobilurin fungicides (azoxystrobin, dimoxystrobin, fluoxastrobin, kresoxim-methyl, metominostrobin, orysastrobin, picoxystrobin, pyraclostrobin, trifloxystrobin), the SDH fungicides, the chloronicotinyl insecticides (clothianidin, dinotefuran, imidacloprid, thiamethoxam, nitenpyram, nithiazin, acetamiprid, nitenpyram, thiacloprid), the insecticidal ketoenols (spirodiclofen, spiromesifen, spirotetramate), fiproles (fiprole, ethiprole) and butenolides, and also pymetrozine, fluopicolid, N-(3′,4′-dichloro-5-fluoro-1,1′-biphenyl-2-yl)-3-(difluoromethyl)-1-methyl-1H-pyrazole-4-carboxamide and N-{2-[3-chloro-5-(trifluoromethyl)-2-pyridinyl]ethyl}-2-(trifluoromethyl)benzamide. Particular preference is also given to herbicides, in particular sulphonylureas, triketones and herbicidal ketoenols, and also safeners.

Nutrients may be present in addition to, or as an alternative to, agrochemical actives. In such formulations the nutrient is typically in a dry form.

The nutrients may preferably be a solid phase nutrient. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Nutrients refer to chemical elements and compounds which are desired or necessary to promote or improve plant growth. Suitable nutrients generally are described as macronutrients or micronutrients. Suitable nutrients for use in the concentrates according to the invention are all nutrient compounds.

Micronutrients typically refer to trace metals or trace elements and are often applied in lower doses. Suitable micronutrients include trace elements selected from zinc, boron, chlorine, copper, iron, molybdenum, and manganese. The micronutrients may be in a soluble form or included as insoluble solids and may be salts or chelated.

Macronutrients typically refer to those comprising nitrogen, phosphorus, and potassium, and include fertilisers such as ammonium sulphate, and water conditioning agents. Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium or sulphur. Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

The WP/WDGs of the present invention provide for improved spore/microbe survivability and therefore better shelf life. They present superior performance with combining the dispersing effect and surprising increase in fungi spore viability, thereby providing improved viability of micro organisms.

The formulations of the present invention have a decrease in viability of comprised biopesticides of no more than 60%, and preferably not more than 50% over 180 days at 25° C. where the viability is as defined in the Examples. There is shown a reduced decrease in spores/microbes compared to no powder and dispersant.

The present invention also provides for improved dispersibility capacity/capability in water and improved wettability in water. The WP/WDGS are found to self-disperse such that they immediately disperse with limited or no agitation required

Additionally, the present invention provides improved mixing tank parameters—such as avoiding the “cake formation” and nozzle clogging.

All of the features described herein may be combined with any of the above aspects, in any combination.

### EXAMPLES

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the adjuvant compositions.

### Sample Preparation

Several liquid binder formulations were formulated according to Table 1 and using the materials listed below.
Mica particles coated with TiO2—particle size 10 μm to 60 μm, bulk density 0.343 g/mL
Kaolin—particle size 1 μm to 20 μm, bulk density 0.471 g/mL
Silica—particle size 15 μm to 25 μm, bulk density 0.166 g/mL
Metasperse 550S—modified styrene acrylic polymer dispersant
Multiwet 8269—dioctyl sodium sulfosuccinate dispersant

TABLE 1
Composition of wettable powders formulations
used during the study (w/w).

| Treatment | Composition |
|---|---|
| C1 | Control (pure conidia) |
| T1 | 5% Metasperse 550S + 65% Mica |
| | coated with TiO₂ + 30% Conidia |
| T2 | 5% Metasperse 550S + 65% Kaolin + 30% Conidia |
| T3 | 5% Metasperse 550S + 60% Kaolin + |
| | 5% Silica + 30% Conidia |
| T4 | 5% Metasperse 550S + 65% Silica + 30% Conidia |

All components were measured and blended until complete homogenisation. After the preparation, all samples were kept in controlled environment at 20° C. and 50% of relative humidity over the entire evaluation period.

### Test Methods

The following test methods were used.

### Microbiology Evaluation

All methods to evaluate the microbiology aspects followed the guidelines contained in IBR R&D WI 387 version 01. All the assessments were performed every 30 days until 180 days after formulation, totalising seven evaluations.

### Conidia Viability Evaluation (Direct Viability)

To access the viability of conidias it was necessary to perform the dilution step for each formulation tested. To access the viability, the dilution with conidias was pipetted in Petri dish with PDA (potato-dextrose-agar) medium. For each Petri dish, were pipetted ten drops of 15 μL.

All Petri dishes were kept in growth chamber under 25° C.±1° in the dark during 15 hours after the addition of drops with conidia in Petri dish with PDA medium. After the incubation period, the conidia germination was paralysed with 8 μL of lactophenol blue colorant. The evaluation was performed after all colorant be absorbed by culture medium. To evaluate the viability of conidias, it was counted 500 conidias in each Petri plate (totalising 5 evaluations per Petri dish). It was considered conidia germinated and activated non-germinated as viable)

The percentage of viable conidias for each drop was obtained using the equation below:

$$Viability ( \% ) = ( N ° of viable conidia / N ° of conidia counted ) \times 100$$

The final result was obtained through the average calculation from 5 drops evaluation.

### Suspensibility

Suspensibility was performed following the guidelines of CIPAC MT 184. Suspensibility of formulations forming suspensions on dilution with water. The method consists at weighting 2.5 g of formulation inside a standard cylindric glass with water, adjusting the water volume to 250 mL and after homogenisation, the system rests inside a 30° C. water bath. Finally, the percentage of solids that is kept suspended in water after rest time is calculated.

### Viability Evaluation

Analysing the data for conidia viability evaluation, the results obtained are presented in the Table 2. This shows the effects of different wettable powder formulations on Trichoderma asperellum conidia viability throughout 180 days after formulation

TABLE 2
Results obtained for percentage of viable conidia throughout
180 days after the formulation process. All results
are expressed in percentage of viable conidia.

| | Day | Day | Day | Day | Day | Day | Day |
|---|---|---|---|---|---|---|---|
| Treatment | 0 | 30 | 60 | 90 | 120 | 150 | 180 |
| C1 | 100 | 72 | 63 | 62 | 49 | 37 | 35 |
| T1 | 100 | 77 | 67 | 58 | 45 | 58 | 46 |
| T2 | 100 | 78 | 69 | 63 | 62 | 51 | 40 |
| T3 | 100 | 81 | 77 | 59 | 65 | 37 | 45 |
| T4 | 100 | 84 | 73 | 62 | 79 | 52 | 57 |

Regardless the formulation composition, the addition of the dispersant and filler improved the percentage of viable conidia at 180 days after formulation process when compared with control (pure conidia).

Even with all variations detected and not differing statistically between each other, the formulations composed by 5% Metasperse 550S+65% mica coated with TiO₂+30% conidia, 5% Metasperse 550S+65% Kaolin+30% conidia, 5% Metasperse 550S+60% Kaolin+5% Silica+30% conidia and 5% Metasperse 550S+65% Silica+30% conidia presented the higher cumulative conidia viability over the evaluation period when compared with the other samples, excepting the control, indicating potential to be used as biopesticide formulation.

Additionally, of the six formulations with highest accumulated viability over the time, four contained the dispersant and filler indicating that use of these can attenuate the natural drop in conidia viability observed in Trichoderma asperellum raw conidia.

In terms of cumulative losses, the results are presented in the following Table 3.:

TABLE 3
Absolute losses observed in conidia viability after 180 days
of exposure to different wettable powders formulations.

| | Day | Day | Day | Day | Day | Day | Day |
|---|---|---|---|---|---|---|---|
| Treatment | 0 | 30 | 60 | 90 | 120 | 150 | 180 |
| C1 | 0 | 28 | 37 | 38 | 51 | 63 | 65 |
| T1 | 0 | 23 | 33 | 42 | 55 | 42 | 54 |
| T2 | 0 | 22 | 31 | 37 | 38 | 49 | 60 |
| T3 | 0 | 19 | 23 | 41 | 35 | 63 | 55 |
| T4 | 0 | 16 | 27 | 38 | 21 | 48 | 43 |

All results are expressed in percentage of accumulative losses in conidia viability

Considering the accumulative losses, it was possible to observe that samples with dispersant and filler presented the lowest values related to losses in viability at 180 days after formulation compared to the control.

Independently of composition and based on the results obtained for accumulative losses, it was observed that inclusion of 5% of Atlox Metasperse 550S into the formulation decreased the losses in conidia viability until 180 days after formulation.

The four formulation where was detected the higher conidia viability values were 5% Metasperse 550S+65% mica coated with TiO₂+30% conidia, 5% Metasperse 550S+65% Kaolin+30% conidia, 5% Metasperse 550S+60% Kaolin+5% Silica+30% conidia and 5% Metasperse 550S+65% Silica+30% conidia.

### Suspensibility Evaluation

Suspensibility for formulated WP with spores was assessed and the results are presented in Table 4 below.

TABLE 4
Suspensibility results

| | | Density | Suspensibility |
|---|---|---|---|
| Sample | Dispersant | (g/mL) | (%) |
| T2 | Multiwet 8269 | 0.380 | 47.62 |

Suspensibility results shows that the selection of a specific filler can directly affect the suspension of solids.

In general and considering the results obtained for these four formulations, the results indicated that use of dispersant and filler can be advantageous, where the dispersant can attenuate the negative effects of the filler towards the Trichoderma asperellum conidia.

It is to be understood that the invention is not to be limited to the details of the above embodiments, which are described by way of example only. Many variations are possible.

1. A wettable power or water dispersible granule comprising:
(i) dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates;
(ii) mineral based filler selected from:
mica particles coated with metal oxide; or
kaolin, silica, or calcium carbonate;
having particle size 1 μm to 100 μm and bulk density 0.2 g/mL to 0.6 g/mL; and
(iii) at least one microorganism selected from fungal spores, or microbes with biopesticide or biofertiliser effects.

2. The wettable power or water dispersible granule according to claim 1, wherein the dispersing agent is selected from a water dispersible styrene (meth)acrylic copolymer.

3. The wettable power or water dispersible granule according to claim 1, wherein the polymeric dispersant has a molecular weight of from 750 to 20,000.

4. The wettable power or water dispersible granule according to claim 1, wherein the metal oxide for mica particle coating is selected from titanium dioxide, iron oxide, chromium oxide, or zirconium oxide.

5. The wettable power or water dispersible granule according to claim 1, wherein the filler is selected from silica or titanium coated mica.

6. The wettable power or water dispersible granule according to claim 1, wherein the weight average molecular weight of the filler particles starting material is in the range from 50,000 to 2,000,000.

7. The wettable power or water dispersible granule according to claim 1, wherein the mineral based filler has a water absorption capability greater than 50%.

8. A wettable power or water dispersible granule comprising:
(i) dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates;
(ii) mineral based filler selected from particles with particle size 1-60 μm, bulk density 0.2-0.6 g/ml, and optionally water absorption capability greater than 50%; and
(iii) at least one microorganism selected from fungal spores, or microbes with biopesticide or biofertiliser effects.

9. The wettable power or water dispersible granule according to claim 8, wherein the mineral based filler is selected from mica particles coated with metal oxide, or kaolin, silica, or calcium carbonate.

10. A pre-blend suitable for forming a wettable power or water dispersible granule of claim 1, the preblend comprising
dispersant selected from sulphonated naphthalene formaldehyde condensates; acrylic copolymers having capped polyethylene glycol side chains on a polyacrylic backbone; copolymer dispersants comprising a copolymer of acrylic acid, hydrophobic monomer, alkylacrylate of a monoalkyl polyethylene glycol, and optionally strong acid derivatives of (meth)acrylic acid; non-ionic graft copolymer of acrylic ester and oxyalkylene; or lignosulfonates,
and mineral based filler selected from:
mica particles coated with metal oxide; or
kaolin, silica, or calcium carbonate;
having particle size 1 μm to 100 μm and bulk density 0.2 g/mL to 0.6 g/mL.

11. The pre-blend according to claim 10, wherein the dispersing agent is selected from a water dispersible styrene (meth)acrylic copolymer.

12. The pre-blend according to claim 10, wherein the filler is selected from silica or titanium coated mica.

13. A method of making a wettable powder or water dispersible granule of claim 1, the method comprising mixing a pre-blend in accordance with claim 10 with at least one microorganism selected from fungal spores or microbes with biopesticide or biofertiliser effects.

14. A formulation suitable for application to vegetation, the formulation comprising a diluted suspension of the wettable powder or water dispersible granule of claim 1.

15. A method of treating vegetation to control pests, the method comprising applying a diluted formulation of claim 1, either to the vegetation or to the immediate environment of the vegetation.

16. A seed treatment formulation, the formulation comprising the wettable powder or water dispersible granule of claim 1.

17. A method of treating seeds to control pests, the method comprising applying a formulation of claim 14 to the seeds.

18. A method for improving viability of at least one beneficial microorganism on an agricultural target comprising the step of combining the beneficial microorganism, selected from fungal spores or microbes with biopesticide or biofertiliser effects, with at least one dispersant and mineral based filler as defined according to claim 1 on the agricultural target.
